(19) United States
(12) Patent Application Publication
(10) Pub. No.: US 2009/0225998 A1
(43) Pub. Date: Sep. 10, 2009

(54) METHOD FOR DETERMINING A TRANSMISSION FUNCTION AND A DEVICE FOR CARRYING OUT SAID METHOD

(76) Inventor: Harry Bachmann, Stafa (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/091,554

(22) PCT Filed: Oct. 3, 2006
(86) PCT No.: PCT/EP06/66994

§ 371 Date: Oct. 6, 2008

(30) Foreign Application Priority Data
Oct. 25, 2005 (CH) 01709/05

(51) Int. Cl. G10K 11/16

(52) U.S. Cl. 381/71.1

(57) ABSTRACT

An unknown transmission function comprising an input signal (x) and an actual output signal (y) is estimated. An estimated output signal (y) is generated by adaptive process (2) using the input signal (x), an error signal (e) is generated from the actual output signal (y) and the estimated output signal (y), and the adaptive process (2) is improved based on the error signal (e), at least one signal path, i.e. a signal path conducting the error signal or a signal path conducting the estimated output signal (y), being impinged upon by a predefined signal in accordance with at least one condition. This makes it possible to substantially optimize adaptive processes or algorithms. Also disclosed are an application of the method, a device, and a use of the device.

### RELATED APPLICATION

This application is a U.S. national phase application under 35 U.S.C. §371 of International Application No. PCT/EP2006/066994 filed Oct. 3, 2006, which claims priority of Switzerland patent application no. 01709/05 filed Oct. 25, 2005.

### TECHNICAL FIELD

The present invention relates to a method for optimizing an adaptive algorithm for determining an unknown transfer function of a room that comprises an input signal and an actual output signal, a use of the method, a device for carrying out the method as well as a use of the device.

### BACKGROUND AND SUMMARY

Sources of noise are increasingly perceived as environmental pollution and are regarded as reduction of life quality. Because sources of noise often cannot be avoided, methods to reduce noises have already been proposed, which are based on the principle of wave cancelling.

The principle of active noise reduction (ANC or “Active Noise Cancelling”) is based on the cancelling of sound waves by interferences. These interferences are generated by one or several electro-acoustic converters, for example by loudspeakers. The signal emitted by the electro-acoustic converters is calculated on the basis of a suitable algorithm and is corrected on a regular basis. As basis for the calculation of the signal emitted by the electro-acoustic converters, information is used that is provided by one or several sensors. This is, on the one side, information on the composition of the signal to be minimized. Thereto, a microphone, for example, can be used that records the sound to be minimized. On the other side, also information is necessary on the remaining residual signal. Microphones can also be used thereto.

The basic principle implemented for active noise reduction has been described by Dr. Paul Lueg in a patent specification going back to the year 1935 having a publication no. AT-141 998 B. This printed publication discloses how noise can be cancelled in a tube by generating a signal having opposite phase.

Further developments lead to a number of specific algorithms, as for example the LMS (Least Mean Square) and related algorithms, as for example the FxLMS and the NLMS.

An algorithm for active noise reduction needs information of at least one sensor (for example a microphone), which determines the residual error—in the following also called error signal. Dependent on implementation and implemented algorithm, a further sensor is provided that provides information on the composition of the signal to be minimized. Furthermore, an adaptive noise reduction system needs one or several actuators (for example in the manner of loudspeakers) in order to output the correcting signal. The information of the sensors must be converted to a corresponding format by an analog-to-digital converter. The signal is converted by a digital-to-analog converter after the processing by the algorithm, and transmitted to the actuators. These converters are limited regarding its resolution as well as regarding its dynamic.

Many algorithms, in particular the known gradient methods, show several instabilities for uncorrelated input signals. Together with the limitations of the converters, this can lead to an uncontrolled behavior of the algorithm for small input signals or for rapid signal changes. This can result in low frequency noises or also in a general instable behavior of the overall system.

The present invention has therefore the object to provide a method for determining a transfer function that does not have the afore-mentioned drawbacks.

This object is resolved by the features of the invention as described below. Advantageous embodiments of the invention, a use of the method, a device for carrying out the method as well as a use of the device are presented.

A method for optimizing an adaptive algorithm, with the aid of which an unknown transfer function is estimated, which has an input signal and an actual output signal, is disclosed, the method consisting in generating an estimated output signal with the aid of an adaptive process by using the input signal, in generating an error signal from the actual output signal and the estimated output signal, and in improving the adaptive process on the basis of the error signal. According to the present invention, at least one of the following signal paths is modified in dependence on at least one condition:
a signal path carrying an error signal;
a signal path carrying the estimated output signal.

Therewith, a method is created for the first time that is in particular suitable for optimizing an adaptive algorithm, because yet non desired signals can be kept away from the adaptive process for a defined period of time by the present invention in particular during the start-up and run-out phase of an active noise reduction system, thereby the system, in its whole, will become more stable and more robust. The moment of actuating or the mentioned condition, respectively, is set in turning on or off the overall system.

A further embodiment of the present invention consists in that a weighting function of the processing unit, having an effect on the error signal and the estimated output signal, is selectable from a number of predefined functions.

In another further embodiment of the present invention it is provided that the condition for changing a signal path depends on the signal carried in this signal path.

Even though the method according to the present invention is particularly suitable for the active noise reduction, other applications are not excluded at all. In contrary: The method according to the present invention is excellently suitable for all adaptive systems for the improvement of the stability and the robustness.

Furthermore, a device is subject of the present invention, comprising the following features:
an adaptive processor unit for the determination of an estimated output signal, an input signal is being fed to the processing unit,
means for determining an error signal from an actual output signal and the estimated output signal, the error signal being fed to the adaptive processor unit, and
a processing unit in at least one of the following signal paths:
   a signal path carrying the error signal;
   a signal path carrying the estimated output signal.

A further embodiment comprises means for determining the weighting function of the processing unit out of a number of predefined weighting functions for the error signal and for the estimated output signal.

For yet another embodiment of the present invention, the processing unit comprises an adaptable weighting unit.

The present invention will be further described with the help of exemplified embodiments by referring to drawings.

### BRIEF DESCRIPTION OF DRAWINGS

FIG. 1 an embodiment of a device according to the present invention, in schematic representation,

FIG. 2 a simplified block diagram of the embodiment depicted in FIG. 1, also in schematic representation,

FIG. 3 a simplified block diagram of a processing unit used in FIG. 2, and

FIG. 4 a signal course for the illustration of a possible manner of functioning of a processing unit according to FIG. 3, and

FIG. 5 a further signal course for the illustration of a possible manner of functioning of a processing unit according to FIG. 3.

### DETAILED DESCRIPTION

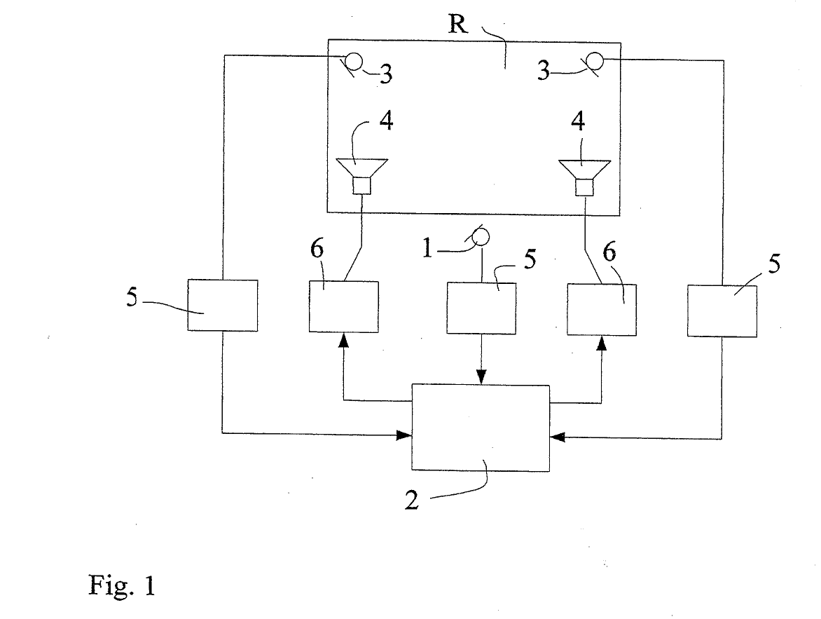

FIG. 1 shows an embodiment of a device according to the present invention for the reduction of noise. It is a so called adaptive noise cancelling system (ANC—Adaptive Noise Canceller), with the aid of which a noise is eliminated or at least reduced, respectively, in a room R by implementing the principle of signal elimination.

Central unit of such an adaptive noise reduction system is an adaptive processor unit 2, which is operationally connected to an external microphone unit 1, the addition “external” indicating that the microphone unit is arranged outside the room R. Therewith, a noise source generally being outside the room R can be better recorded. Furthermore, two internal microphone units 3 and two loudspeaker units 4 are provided in the room R, which are all operatively connected to the adaptive processor unit 2. As can be seen from FIG. 1, a processing unit 5, 6 is provided between one of the microphone units 1, 3 and the adaptive processor unit 2, or between one of the loudspeaker units 4 and the adaptive processor unit 2, respectively, which makes it possible to modify the respective signal path.

In the adaptive processor unit 2, a reduction signal is now fed into the room R via the loudspeakers 4 on the basis of the signal recorded by the microphone unit 1 such that an noise signal reaching the room R via the walls or windows is cancelled or reduced, respectively, by signal cancelling or reduction, respectively. In order that this can be reached with success under changing conditions, an error signal is recorded with the aid of the microphone units 3 and fed back to the adaptive processor unit 2 such that the calculations of the reduction signal can be improved in the adaptive processor unit 2, and, in the following, a signal cancelling or signal reduction, respectively, can be obtained.

It is explicitly pointed out that any number of microphone units 1, 3 and loudspeaker units 4 are conceivable without leaving the principle of the present invention. In addition, other converting units than the microphone units 1, 3 and/or the loudspeaker units 4 are conceivable.

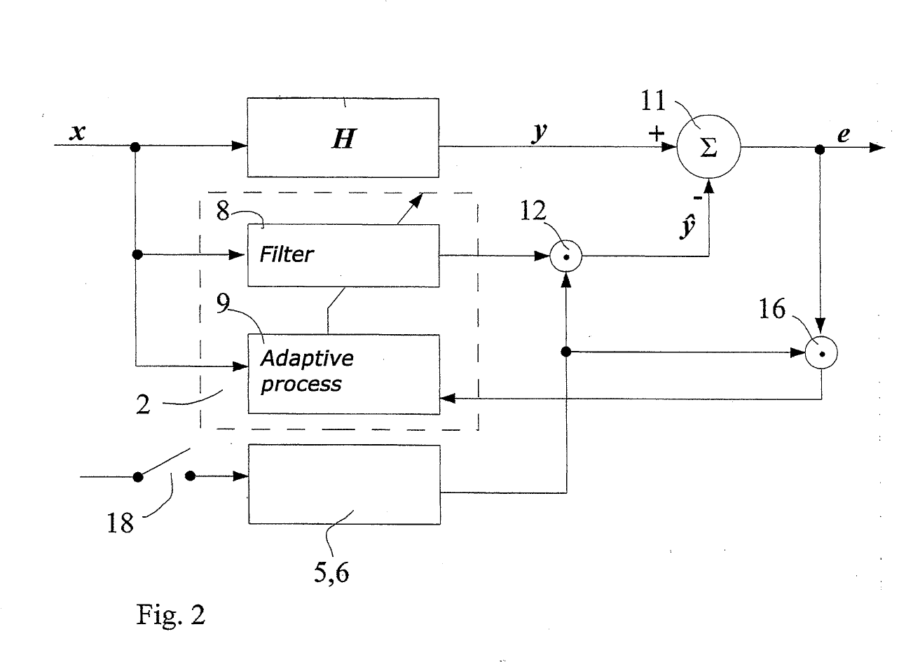

FIG. 2 shows a block diagram of a simplified embodiment of the present invention according to FIG. 1. According to the present invention, signals can be modified in individual or several signal paths. Therefore, a processing unit 5, 6 is provided—as depicted in FIG. 2—which influences the estimated output signal ŷ as well as the error signal e by multiplier units 12 and 16. In a further embodiment, it is conceivable that for each signal to be modified, i.e. for each signal path, a processing unit 5, 6 is provided, whereas the weighting functions, which are used for the signals in the signal paths, can be different.

A weighting function, which is used in the processing unit 5, 6 for a signal of the signal path, modifies the signal, for example, during the time interval of the initialization of the overall system (i.e. at or immediately after turning on, respectively), or during the time interval after interrupting or turning off the signal according to the predefined function, respectively. Hence the output of the adaptive processor unit 2 is modified in the multiplier unit 12 according to the weighting function. The modified signal is passed on to the loudspeaker unit—again in turn this is depicted in FIG. 1.

The signal path of a microphone unit—in a further embodiment of the invention—is modified in a uniform manner and is modified in a processing unit with the respective weighting function afterwards. The result is passed on to the adaptive processor unit 2—again in view of the embodiment according to FIG. 1. The adaptive processor unit 2 obtains as a consequence an error signal e according to the predefined weighting functions. This embodiment particularly makes sense, if a noise must be actively minimized according to a preset weighting function in a determined time interval in order to avoid abrupt signal changes. As a consequence, this also has a frequently desired smoothing effect for rapid signal changes.

The mentioned embodiment also contributes to the stabilization of the overall system substantially, because otherwise these rapid transitions are detected by the sensors as well—i.e. by the microphone units 3—for detecting the residual noises. Therewith the adaptive noise reduction system can optimally adapt to the momentary situation in particular for input signals that are difficult to process.

Therefore possible deficiencies of the analog-to-digital converters and digital-to-analog-converters or other components needed for the digital system lose ground.

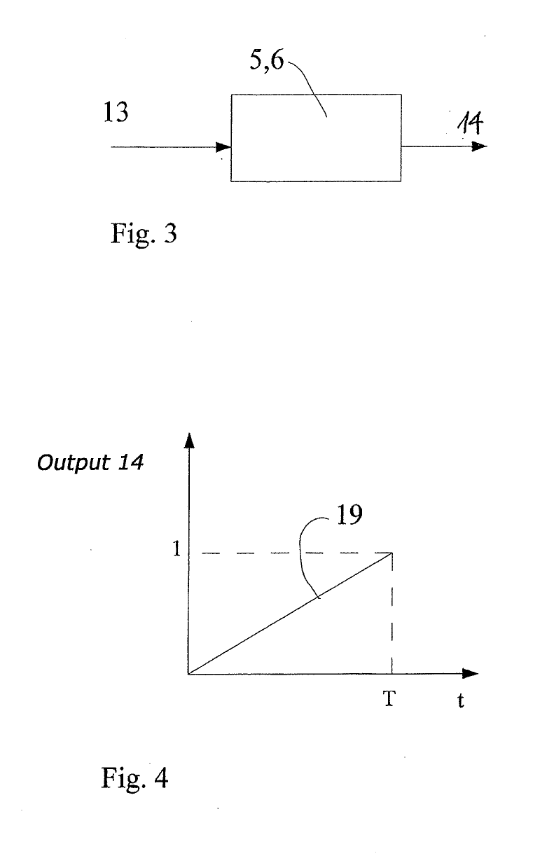

The input signal, as depicted in FIG. 2, is fed to the processing unit 5, 6, which is carried over a switching unit 18. The switching unit 18 is a main control switch, for example, via which the power supply to the overall system can be turned on or off, respectively. Thereby, a change in state of the switch of the switching unit 18 serves as actuating point in time for a weighting function. Thus, the weighting is changed in function of time according to a predefined function from the point in time of a change in state of the switch the weighting is changed. Different weighting functions and their use are specified on the basis of FIGS. 3 to 5.

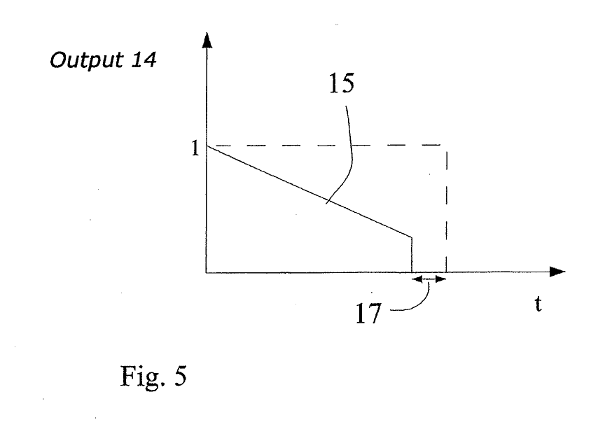

FIG. 3 shows one of the processing units 5, 6, to which an input signal 13 is fed triggering a determined change of a weighting function in dependence on a change of state. In the processing unit 5, 6, an output signal 14 is generated, which results from the course of the weighting function according to FIG. 4 or FIG. 5, for example. Thereby, an arbitrary weighting function can be used, in particular an increasing ramp function 19 according to FIG. 4, or a decreasing ramp function 15 according to FIG. 5, a constant value, an exponential increase/decrease or a combination thereof. In the diagram depicted in FIG. 4, the horizontal axis represents the time, and the vertical axis represents the output signal 14. The following can be derived from of the illustrated graph of FIG. 4: The output signal 14 obtains the standard value, which is standardized to the value 1 (100%) according to the determined ramp function 15 after a time T.

FIG. 5 illustrates a decreasing ramp function, the function having the value 0 (0%) in the interval 17, which has an advantageous effect on a stabilizing behavior. As the weighting function according to FIG. 4 is suitable for the initializing procedure, the weighting function according to FIG. 5 can excellently be used during the switch-off procedure.

1. Method for determining an unknown transfer function (H) of a room (R) that comprises an input signal (x) and an actual output signal (y), the method comprising:
generating an estimated output signal (ŷ) by using the input signal (x) with the aid of an adaptive process (2),
generating an error signal (e) from the actual output signal (y) and the estimated output signal (ŷ), and
improving the adaptive process (2) on the basis of the error signal (e), and
modifying at least one signal of the following signal paths in dependence on at least one condition:
a signal path carrying the error signal (e);
a signal path carrying the estimated output signal (ŷ).

2. Method according to claim 1, wherein the condition for changing a signal path is dependant on the signal (x, e, ŷ) carried out in this signal path.

3. Method according to claim 1, including modifying signals by several signal paths at the same time.

4. Method according to claim 1, including carrying out the modification of a signal according to a determined weighting function.

5. Use of the method according to claim 1 for the active noise reduction in a room (R).

6. Device for carrying out the method according to claim 1, the device comprising:
an adaptive processor unit (2) for the determination of an estimated output signal (ŷ), an input signal (x) being fed to the processor unit (2),
means (11) for determining an error signal (e) from an actual output signal (y) and the estimated output signal (ŷ), the error signal (e) being fed to the adaptive processor unit (2), and
a processing unit (5, 6) in at least one of the following signal paths:
a signal path carrying the error signal (e);
a signal path carrying the estimated output signal (ŷ).

7. Device according to claim 6, wherein means for determining a level or a mean power of a signal (x, e, ŷ) are provided, the means being operatively connected to at least one processing unit (5, 6).

8. Device according to claim 7, wherein the means for determining a level or a mean power of a signal (x, e, ŷ) in a signal path are operatively connected to a unit in the same signal path.

9. Device according to claim 6, including several switching units which are activate-able at the same time.

10. Device according to claim 6, wherein the processing unit (5, 6) has a predefined weighting function.

11. Device according to claim 6, wherein a plurality of processing units (5, 6) are operatively interconnected.

12. Use of the device according to claim 6 for the active noise reduction in a room (R).
